(19) United States
(12) Patent Application Publication
(10) Pub. No.: US 2006/0005410 A1
(43) Pub. Date: Jan. 12, 2006

(54) Virtual fixturing

(76) Inventor: Scott Mullen, Jim Thorpe, PA (US)

Correspondence Address: SCOTT MULLEN, 110 W. BROADWAY, JIM THORPE, PA, 18229, US

(21) Appl. No.: 10/781,436

(22) Filed: Jul. 10, 2004

(51) Int. Cl. G01B 5/20

(52) U.S. Cl. 33/551

(57) ABSTRACT

A Virtual Fixture includes 3 main components, Base Plate, Riser Base, & Riser. The Base Plate is connected to the Base Riser by a threaded rod, a coupler, and a pivot with locking device. The Riser is attached to the Riser Base with circular slots for additional rotation ability. The Riser has a threaded rob and coupler which holds a tooling sphere or similar probe. The Base Plate has multiple slots for different configurations to use multiple probes. This enables user to locate, part or component, for quality inspection using datum target points.

### BACKGROUND

I worked in Aerospace Quality Engineering and Automotive Racing fields for a few decades. And have used the most current technologies. Common Industry Practice such as Aerospace, Automotive and Commercial Manufacturers use Tooling Points or Datum Target Points to Locate or Fixture a part. Usually 3 points on a plane (Primary), 2 points on a Perpendicular plane (Secondary), and 1 point to lock rotation (Tertiary). The purpose is to achieve the best condition (True Position) for measuring or machining the part.

Currently the most versatile fixturing is called Modular which consists of a Base Plate with prearranged multiple holes, with pins fit to the holes, Modular Fixturing is limited to the distance between the holes with pins, the only way to locate between 2 pins is by adding shims or other components. This increases costs to manufacture, operator set up time.

### OPERATIONS DESCRIPTION

By bolting assembled base plate on machined surface to secure location. Then choosing 1 tooling point to position by turning knob on the side of Base Plate (clockwise or counter Clockwise) will move point along horizontal plane (“X” or “Y”) then lock with set screw. Secondly, pivot Riser Base to desired location which may include turning Knob (clockwise or counter clockwise) on the side of Riser Base to achieve location, and lock by tightening screws. Thirdly turn Knob (clockwise or counter clockwise) at the top of Riser to achieve desired location and lock with set screw.

The set Point can be measured by Height Gage or similar device for exact location, or can be set to predetermined Gage Block or Blocks and turn Knobs on fixture to intersect Tooling ball/point with Gage Block.

Repeat for each individual Tooling Ball/Point until you have achieved your final location. As a result you end up with a precise location of a working part, which then all theoretical centers and positioning can be measured or machined.

### OBJECTIVES/ADVANTAGES

There are two main objectives, with many subsequent advantages

One objective was to create a fixture that was better than current methods of holding parts Viral Fixture lets user change from one part to be inspected to a different part, without adding or taking off multiple components to get proper configuration for new part.

Second Objective was to create it as simple as possible. By using a Base Plate configured to your needs. you would only need to have one fixture which enabled user to get same results faster while keeping manufacturing costs and set-up times down.

### VIRTUAL FIXTURING REFERENCE NUMERAL LISTING

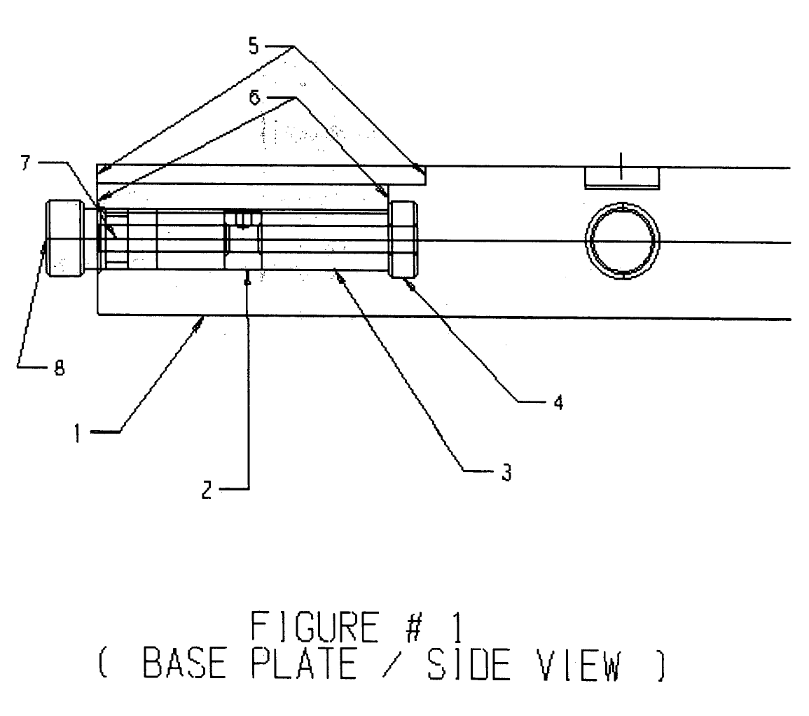

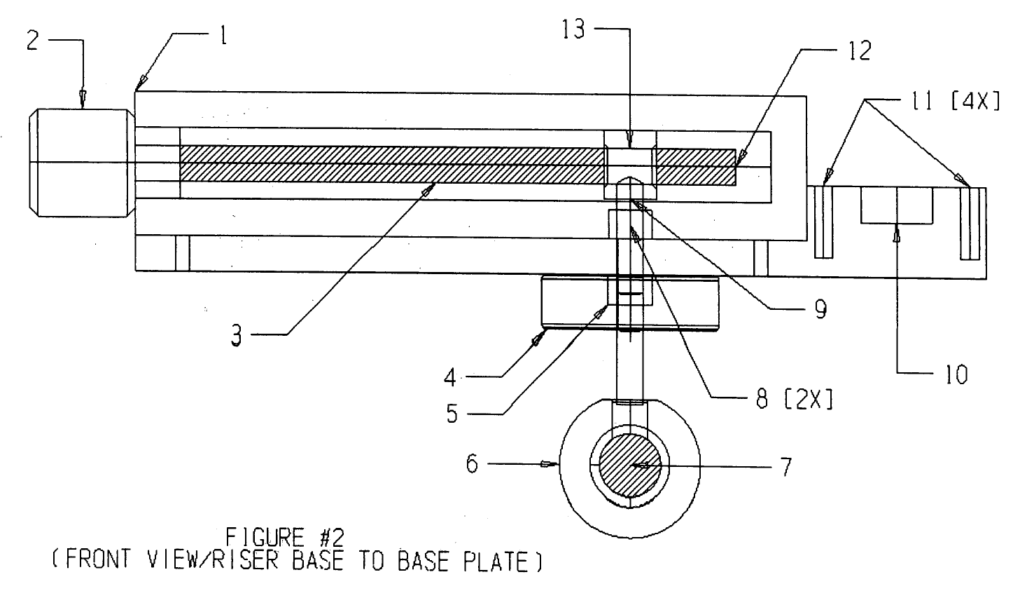

FIG. 1:
1=Base Plate
2=Coupler (threaded center/attaches to Pivot under Riser Base)
3=Bored Hole, for Assembly to fit in
4=Bearing (2× at both ends of threaded rod)
5=Slot for Pivot
6=Slot for connecting Coupler to Pivot
7=Threaded Rod
8=Knob

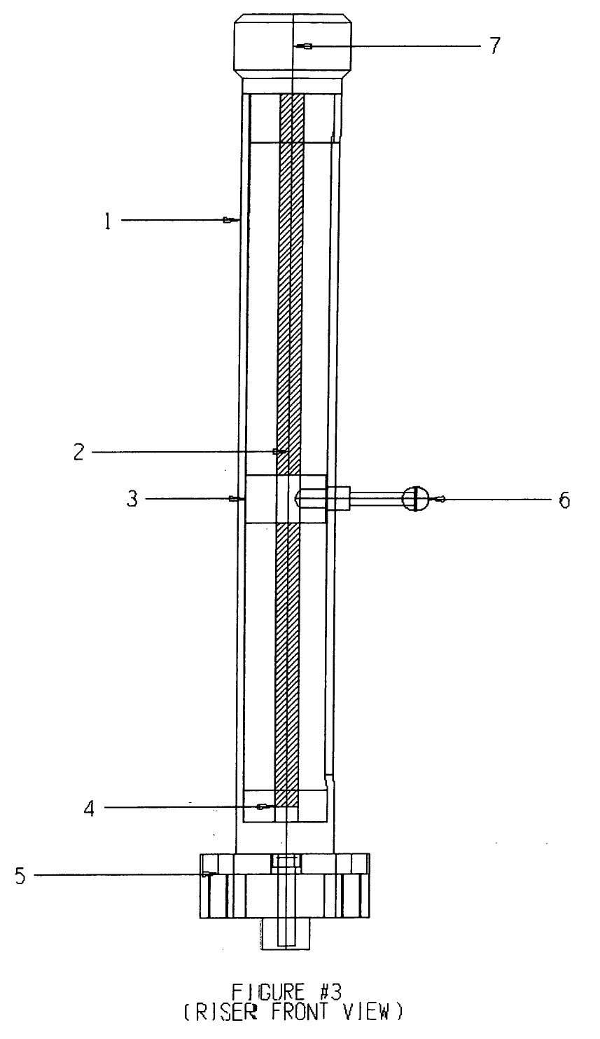

FIG. 2:
1=Riser Base
2=Knob
3=Threaded Rod
4=Pivot
5=C′ Bore (for connecting Pivot to Base Plate Coupler/and connecting Riser Base to Pivot)
6=Coupler (Base Plate)
7=Threaded Rod (Base Plate)
8=Bolts (locking Riser Base)
9=Pivoting Pin
10=C′ Bore (for Riser pivoting/and location)
11=Threaded Holes to lock Riser rotation
12=Bearings (at both ends of threaded rod)
13=Coupler (Riser base)

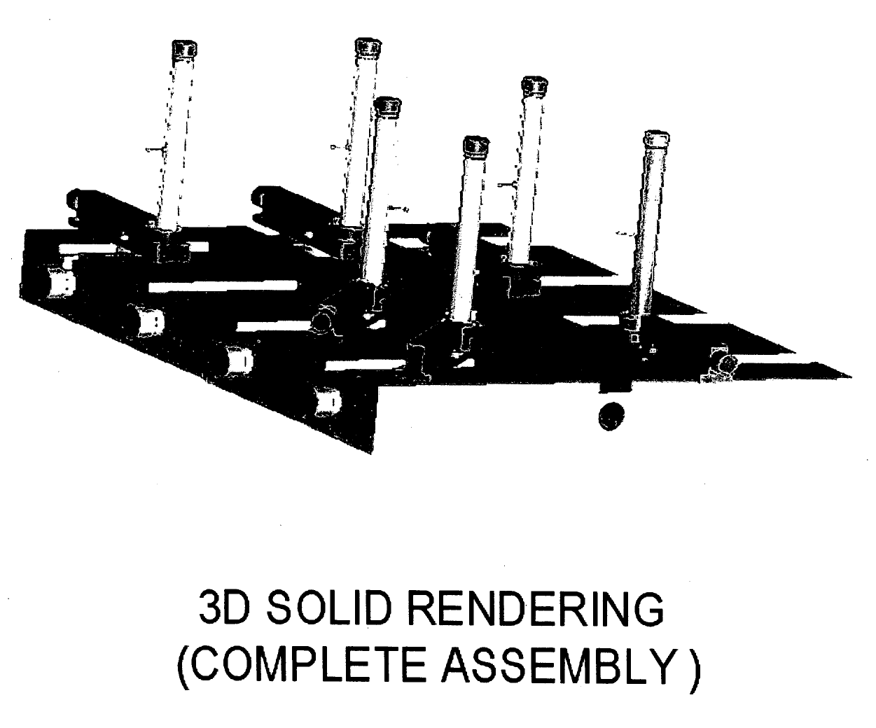

FIG. 3:
1=Riser body
2=Threaded Rod
3=Coupler (Riser to Probe)
4=Bearings (at both ends of threaded rod)
5=Slots (rotated around base of Riser connecting to Riser Base)
6=Probe
7=Knob

1. Using multiple probes, {each individual probe is attached to a vertical threaded rod (which rotates 360 degrees at the base, and the base is attached to a horizontal threaded rod, both rods are set on top of a pivot (which rotates assembly 360 degrees), the pivot is attached to another threaded rod in a base plate; by using described process (steps A-D)} enables one fixture to locate every possible component/part for Inspection without changing fixtures or fixture components, {within maximum travel of base plate size}.
Process:
A: By turning knob at the top of vertical threaded rod enables infinite location of probe within maximum travel of “Z” axis.
B: By turning knob at end of horizontal threaded rod enables infinite location of probe within maximum travel of “X” or “Y” axis
C: By turning knob at the end of threaded rod in base plate enables infinite location of probe within maximum travel of “Y” or “X” axis.
D: By rotating pivot enables infinite location of probe in Angular location or “C” axis.

2. Having all threaded rods geared to electric servo motors and controlled by computer numerical control. Enables the same infinite loacation of each probe, within maximum travel, with faster accurate placement of probes.
